(19) United States
(12) Patent Application Publication
(10) Pub. No.: US 2026/0249188 A1
(43) Pub. Date: Aug. 27, 2026

(54) ONE OR MORE NON-TRANSITORY COMPUTER-READABLE MEDIA, INFORMATION PROCESSING METHOD, AND INFORMATION PROCESSING SYSTEM

(71) Applicant: Nintendo Co., Ltd., Kyoto (JP)

(72) Inventors: Masahiro NAKAMURA, Kyoto (JP); Tomohiro NAKATANI, Kyoto (JP)

(21) Appl. No.: 19/450,439

(22) Filed: Jan. 15, 2026

(30) Foreign Application Priority Data
Feb. 21, 2025 (JP) 2025-026716

(51) Int. Cl. A63F 13/57

(52) U.S. Cl. CPC A63F 13/57

(57) ABSTRACT

In an example of an information processing system according to an exemplary embodiment, regarding a plurality of regions defined by dividing inside of a virtual space, based on weather information held with each of the regions, a virtual weather is controlled, any of a plurality of courses defined in partial ranges of a field is set on the field, a race by a plurality of movable body objects including an operation target object is started on the course, and during the race, if a first event occurs, the weather information regarding the regions corresponding to positions of the plurality of movable body objects is set to information indicating a first weather.

### CROSS REFERENCE TO RELATED APPLICATION

This application claims priority to Japanese Patent Application No. 2025-026716 filed on February 21, 2025, the entire contents of which are incorporated herein by reference.

### FIELD

An exemplary embodiment relates to one or more non-transitory computer-readable media, an information processing method, an information processing system, and an information processing apparatus that enable the execution of a racing game.

### BACKGROUND AND SUMMARY

Conventionally, there is a racing game where a player object is moved, and the player object can attack another movable body object.

In the above conventional game, a weather is not set for the place where another movable body object is.

The exemplary embodiment discloses one or more non-transitory computer-readable media, an information processing method, an information processing system, and an information processing apparatus in which a weather can set for the place where another movable body object is in a racing game.

The exemplary embodiment employs the following configurations.

### First Configuration

A first configuration is one or more non-transitory computer-readable media having stored therein instructions that, when executed, cause one or more processors of an information processing apparatus to execute operations including: based on an operation input, causing an operation target object to run on a field in a virtual space. The operations include regarding a plurality of regions defined by dividing inside of the virtual space, based on weather information held with respect to each of the regions, controlling a virtual weather in a range corresponding to the region in the virtual space. The operations include setting any of a plurality of courses defined in partial ranges of the field on the field and starting a race by a plurality of movable body objects including the operation target object on the course, and performing the race by causing the operation target object and the movable body objects to run along the course on the field. The operations include during the race, if a first event occurs, setting the weather information regarding the regions corresponding to positions of the plurality of movable body objects to information indicating a first weather.

Based on the above, in a case where a course is set in a different range on a field with respect to each race, and if a first event occurs, it is possible to change the weather of a region including the place where a movable body object is during the race.

### Second Configuration

According to a second configuration, in the above first configuration, the weather information may be a rainfall parameter indicating a degree of rainfall, and the information indicating the first weather may be a value of the rainfall parameter with which a rainfall process is performed at least by the controlling of the weather.

Based on the above, it is possible to perform a rainfall process on the region including the place where the movable body object is during the race.

### Third Configuration

According to a third configuration, in the above second configuration, the operations may further include setting the field in a range where the rainfall process is being performed to be more slippery than in a case where the rainfall process is not being performed, and causing the movable body objects to run.

Based on the above, it is possible to make the region on which the rainfall process is performed slippery.

### Fourth Configuration

According to a fourth configuration, in any of the above first to third configurations, the operations may further include, if the first event occurs during the race, setting the weather information regarding the at least one region corresponding to a first range including the position of each of the movable body objects other than a lead movable body object among the movable body objects in the race, and the region corresponding to a second range larger than the first range and including the position of the lead movable body object in the race to the information indicating the first weather.

Based on the above, it is possible to prevent a lead movable body object from quickly escaping from a region where the weather changes.

### Fifth Configuration

According to a fifth configuration, in any of the above first to fourth configurations, the first event may be a first obstruction instruction to obstruct another movable body object by any of the movable body objects. The operations may further include, in accordance with the first obstruction instruction, further producing an effect of obstructing the running of the other movable body object.

Based on the above, it is possible to obstruct the running of another movable body object and further change the weather of a region corresponding to the position of the movable object.

### Sixth Configuration

According to a sixth configuration, in the above fifth configuration, the operations may further include, in accordance with the first obstruction instruction, producing an effect of obstructing the running of the other movable body object ranking higher than the movable body object for which the first obstruction instruction is given in the race; and setting the weather information regarding the regions corresponding to the positions of all the movable body objects to the information indicating the first weather.

Based on the above, it is possible to produce an effect of obstructing the running of only another movable body object ranking high and also change the weather of regions corresponding to the positions of all movable body objects.

### Seventh Configuration

According to a seventh configuration, in any of the above first to sixth configurations, the plurality of regions may be hexagonal regions adjacent to each other with respect to a horizontal direction.

Based on the above, it is possible to manage weather information in a plurality of hexagonal regions.

### Eighth Configuration

According to an eighth configuration, in any of the above first to seventh configurations, the operations may further include, if a second event occurs, setting the weather information regarding any of the regions to the information indicating the first weather.

Based on the above, in a game where the weather of a region in a virtual space is changed in accordance with the occurrence of a second event, it is possible to change the weather of a region corresponding to the position of a movable body object in accordance with the occurrence of a first event.

### Ninth Configuration

According to a ninth configuration, in any of the above first to eighth configurations, the race may be a multiplay race based on communication between a plurality of information processing apparatuses, and the operations may further include: causing the plurality of information processing apparatuses to share the weather information regarding the region; and controlling the virtual weather in the virtual space based on the shared weather information.

Based on the above, it is possible to share weather information with another information processing apparatus in a multiplay racing game.

### Tenth Configuration

According to a tenth configuration, in any of the above second to ninth configurations, the operations may further include, as the rainfall process, at least drawing a sky in a range corresponding to the region by a blending texture for a rain cloud.

Based on the above, it is possible to generate a rain cloud in a sky above in a virtual space by blending a texture for a rain cloud.

### Eleventh Configuration

According to an eleventh configuration, in any of the above second to tenth configurations, the operations may further include, as the rainfall process, if the operation target object or a virtual camera is within a range corresponding to the region, at least drawing rain.

Based on the above, if an operation target object or a virtual camera is within a range corresponding to the region, it is possible to draw rain.

Another configuration may be an information processing system that executes the above game program, an information processing apparatus, or an information processing method.

According to the exemplary embodiment, if a first event occurs, it is possible to change the weather of a region including the place where a movable body object is during a race.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram showing an example of the entirety of a field F in a virtual space;

FIG. 4 is an example non-limiting diagram showing an example of an intra-base route AR1 set in a base area A1;

FIG. 5 is an example non-limiting diagram showing an example of a game image displayed on a display device during a racing game according to an exemplary embodiment;

FIG. 6 is an example non-limiting diagram showing an example of a game image displayed when a player object 50 comes into contact with an item acquisition object 70 and acquires an item X;

FIG. 7 an example non-limiting diagram showing an example of a game image displayed when a first effect of the item X is produced by the player object 50 using the item X;

FIG. 8 is an example non-limiting diagram showing an example of a game image displayed after the player object 50 uses the item X and is an example non-limiting diagram showing an example of a game image displayed when rain is falling on the periphery of the player object 50 through the use of the item X;

FIG. 9 is an example non-limiting diagram of a part of the field including a route R where the player object 50 is running when viewed from above in the virtual space and is an example non-limiting diagram showing examples of regions where rain falls;

FIG. 10 is an example non-limiting diagram showing examples of various pieces of data stored in the game system 1;

FIG. 11 is an example non-limiting flow chart showing an example of game processing;

FIG. 12 is an example non-limiting flow chart showing an example of a player object control process in step S13;

FIG. 13 is an example non-limiting flow chart showing an example of a second effect production process in step S26;

FIG. 14 is an example non-limiting flow chart showing an example of a weather control process in step S16; and

FIG. 15 is an example non-limiting flow chart showing an example of a rainfall process in step S45.

### DETAILED DESCRIPTION OF NON-LIMITING EXAMPLE EMBODIMENTS

### Game System Configuration

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, and a plurality of buttons (an A-button, a B-button, an X-button, a Y-button, an L-button, and an R-button), and an analog stick, as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a "controller".

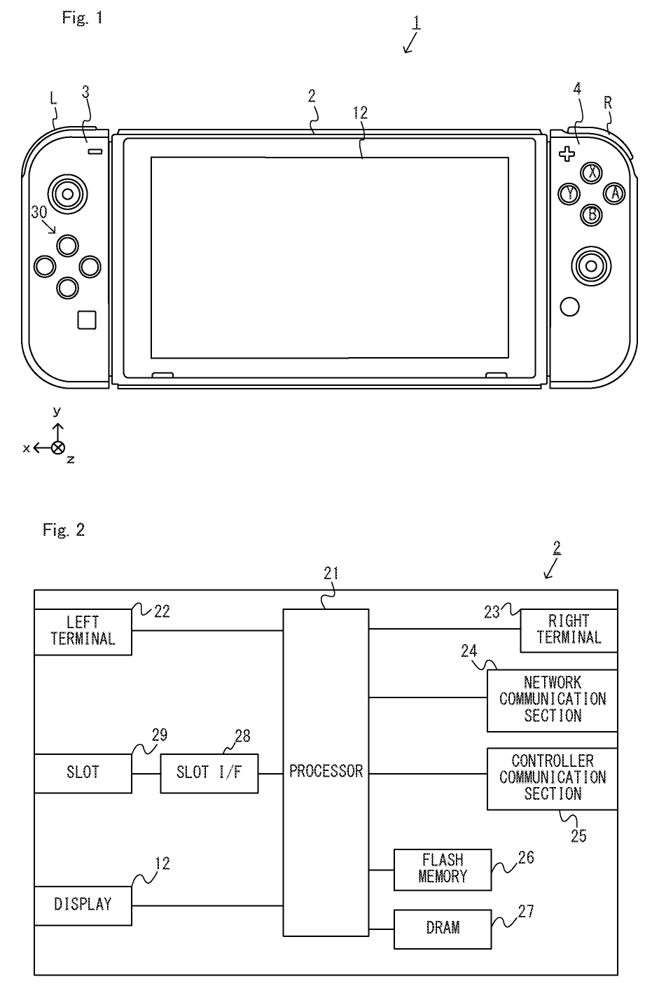

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as "I/F") 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi (registered trademark) standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called "local communication" in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

It should be noted that, in addition to the elements shown in FIG. 2, the main body apparatus 2 includes a battery that supplies power and an output terminal for outputting images and audio to a display device (e.g., a television) separate from the display 12.

### Overview of Game

Next, a description is given of an overview of a game executed by the game system 1. The game according to the exemplary embodiment is a racing game where a plurality of movable body objects are moved in a virtual space (a game space). For example, the main body apparatus 2 communicates with another main body apparatus 2 via a network (e.g., the Internet), whereby the racing game is performed in a multiplay mode by a plurality of players. Although a description is given below of a case where the racing game is performed in the multiplay mode by a plurality of players, the racing game may be performed in a single play mode by a single player.

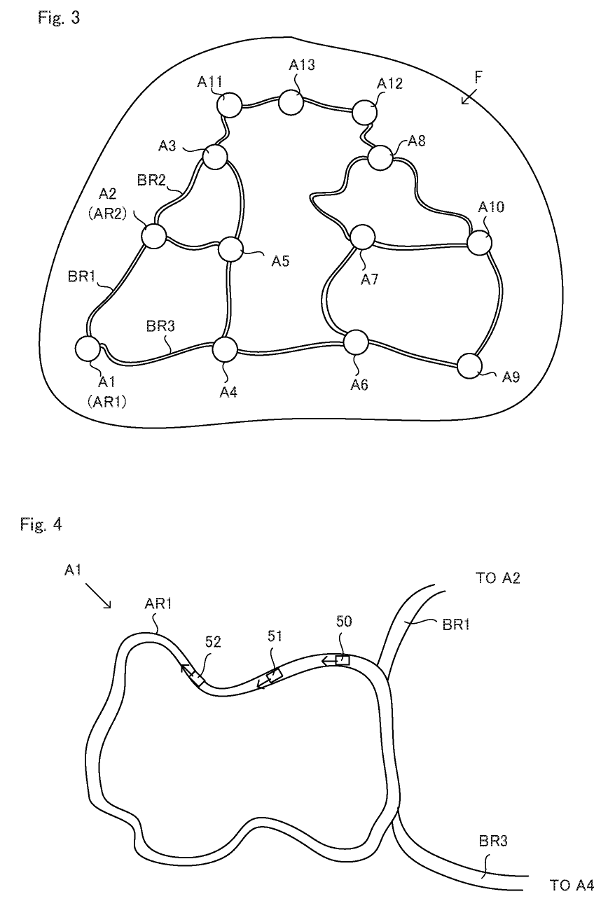

First, a description is given of a field in the virtual space where the game according to the exemplary embodiment is performed. FIG. 3 is a diagram showing an example of the entirety of a field F in the virtual space.

In the exemplary embodiment, a broad field F is set in the virtual space (the game space). As shown in FIG. 3, a plurality of base areas A are set on the field F in the virtual space. In each base area A, an intra-base route AR around which a player object can take a lap is set. A plurality of base areas are linked together by an inter-base route BR where the player object can run. Hereinafter, the intra-base route AR and the inter-base route BR are collectively referred to as a "route R".

A player can select any of a plurality of courses set on the field and perform the racing game on the selected course. For example, if a base area A1 is selected, a course where the player object takes multiple laps around an intra-base route AR1 set in the base area A1 is set, and the racing game where the plurality of movable body objects including the player object move along the course is performed. If a base area A2 is selected, a course where the player object takes multiple laps around an intra-base route AR2 set in the base area A2 is set, and the racing game is performed along the course. If a course including at least one inter-base route BR is selected, the course including the inter-base route BR is set, and the racing game is performed on the course. For example, a course including an inter-base route BR1 and the intra-base route AR2 is set, and the racing game is performed on the course.

FIG. 4 is a diagram showing an example of the intra-base route AR1 set in the base area A1. For example, a course is set along the intra-base route AR1, and a race is performed on the course. In this case, a plurality of movable body objects including a player object 50 and other movable body objects (51, 52, and the like) as competitors start from a starting point, take a predetermined number of laps (e.g., three laps) around the intra-base route AR1 along the course, and reach a goal point.

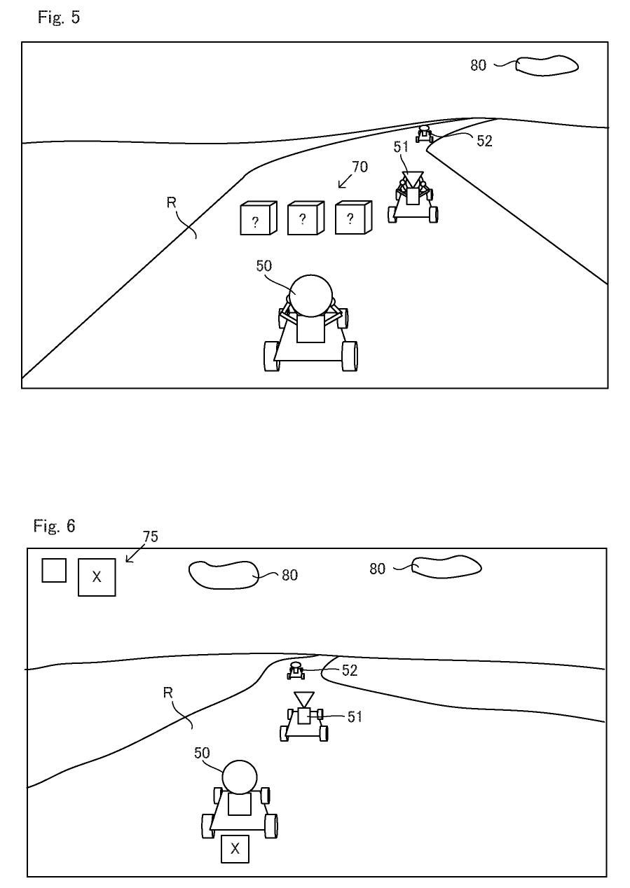

FIG. 5 is a diagram showing an example of a game image displayed on a display device during the racing game according to the exemplary embodiment.

As shown in FIG. 5, a route R is set in the virtual space, and the state where the plurality of movable body objects including the player object 50 are running on the route R is displayed. The player object 50 is an object operated by a player of the main body apparatus 2 and is controlled based on operation data from the controllers 3 and 4. For example, at a position a certain distance away from the player object 50, a virtual camera that moves by following the player object 50 is placed, and a game image is generated based on the virtual camera. The generated game image is displayed on a display device (the display 12 or another display device). The range of the field of view of the virtual camera includes the sky in the virtual space, and a part of the sky is displayed. The current weather is a sunny weather, and a cloud 80 is displayed in the sky above.

The other movable body object 51 as a competitor of the player object 50 is running ahead of the player object 50. For example, the other movable body object 51 is an object operated by a second player and is controlled based on game data received from a main body apparatus 2 of the second player. The other movable body object 52 as a competitor of the player object 50 is also running further ahead of the other movable body object 51. The other movable body object 52 is an object operated by a third player and is controlled based on game data received from a main body apparatus 2 of the third player. In addition to the other movable body objects 51 and 52, other movable body objects as competitors of the player object 50 operated by a plurality of other players participate in the racing game. At least one of the plurality of other movable body objects may be an object (a non-player object) automatically controlled by the processor 21.

As shown in FIG. 5, an item acquisition object 70 is placed in the virtual space. The item acquisition object 70 is an object that allows a movable body object to acquire any of a plurality of types of items. Specifically, if a movable body object comes into contact with the item acquisition object 70, any of the plurality of types of items is given to the movable body object. If the item is given to the movable body object, the movable body object enters the state where the movable body object possesses the item. In the state where the movable body object possesses the item, if an instruction to use the item is given, the item is used. Each movable body object can simultaneously possess up to a predetermined number of (e.g., two) items. The items possessed by the movable body object are used in order of acquisition.

When an item is used, the item produces an effect according to the type of the item. For example, an item X among the plurality of types of items has a first effect. The first effect is the effect of obstructing the running of a movable body object going ahead. Another item has the effect of temporarily increasing the velocity of a movable body object that uses the other item. In addition to these, a plurality of types of items having different effects, such as an item having an attack effect (a running obstruction effect) on another movable body object, an item that gives an advantage to a movable body object that uses the item, and the like, are prepared.

The plurality of types of items include an item having a high effect and an item having a low effect. When a movable body object comes into contact with the item acquisition object 70, the type of an item to be given to the movable body object is randomly determined in accordance with the current ranking of the movable body object. The lower the current ranking of the movable body object is, the higher the effect of the item to be given to the movable body object is likely to be.

FIG. 6 is a diagram showing an example of a game image displayed when the player object 50 comes into contact with the item acquisition object 70 and acquires the item X.

For example, if the player object 50 comes into contact with the item acquisition object 70, the item X is given to the player object 50, and the player object 50 enters the state where the player object 50 possesses the item X. In the state where the player object 50 possesses the item X, an icon indicating the item X is displayed in an item possession region 75. In the state where the player object 50 possesses the item X, the item X is also displayed near the player object 50.

In the state where the player object 50 possesses the item X, if an instruction to use the item X is given, the player object 50 uses the item X. If player object 50 uses the item X, the item X is consumed, and the first effect of the item X is produced. An instruction to use the item X is an example of the occurrence of a first event.

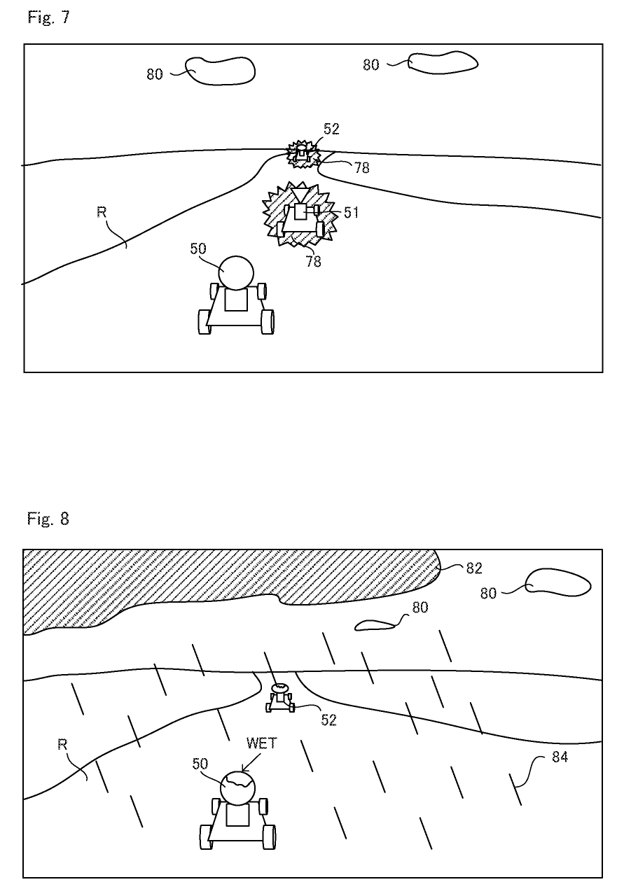

FIG. 7 is a diagram showing an example of a game image displayed when the first effect of the item X is produced by the player object 50 using the item X.

As shown in FIG. 7, if the item X is used, an effect image 78 indicating that the first effect of the item X is produced is added to the movable body objects 51 and 52 going ahead. For example, the effect image 78 may be an image representing thunder. If the first effect is produced, the movable body objects going ahead enter a temporarily disadvantageous state in the racing game. For example, the movable body objects 51 and 52 going ahead temporarily stop, decrease in size, spin, or decrease in velocity. The first effect (the running obstruction effect) through the use of the item X is produced only on a movable body object moving ahead of a movable body object that uses the item X, and is not produced on a movable body object moving behind the movable body object that uses the item X. For example, if the movable body object 53 is running behind the player object 50, the running obstruction effect is not produced on the movable body object 53.

The item X has a second effect in addition to the above first effect. The second effect of the item X is the effect of causing rain or snow to fall in a partial region of the virtual space. Specifically, the second effect is the effect of causing rain or snow to fall on the peripheries of the movable body objects participating in the racing game.

FIG. 8 is a diagram showing an example of a game image displayed after the player object 50 uses the item X, and is a diagram showing an example of a game image displayed when rain is falling on the periphery of the player object 50 through the use of the item X.

As shown in FIG. 8, a rain cloud 82 is generated in the sky above a region where the player object 50 and the other movable body object 52 are running. In a region directly under the rain cloud 82, a raindrop effect 84 indicating that rain is falling is displayed moving from above to below. In the sky above on the right side of the center with respect to the virtual camera and in the sky above in the depth direction, clouds 80 that are not rain clouds are displayed, and it is sunny in these regions. That is, a rain cloud 82 is generated in the sky above the region where the player object 50 and the other movable body object 52 are running, but a rain cloud 82 is not generated in another region.

Specifically, if the item X is used, as the second effect, a rain cloud 82 is generated in a predetermined range corresponding to the positions of the movable body objects. In a region under the rain cloud 82, rain falls, and a ground and the movable body objects included in the region have wet appearances. In the region where rain is falling, fog is generated in the virtual space, and the region is displayed blurrily overall and is also darker than when it is sunny. In the region where rain is falling, headlights of the movable body objects also light up.

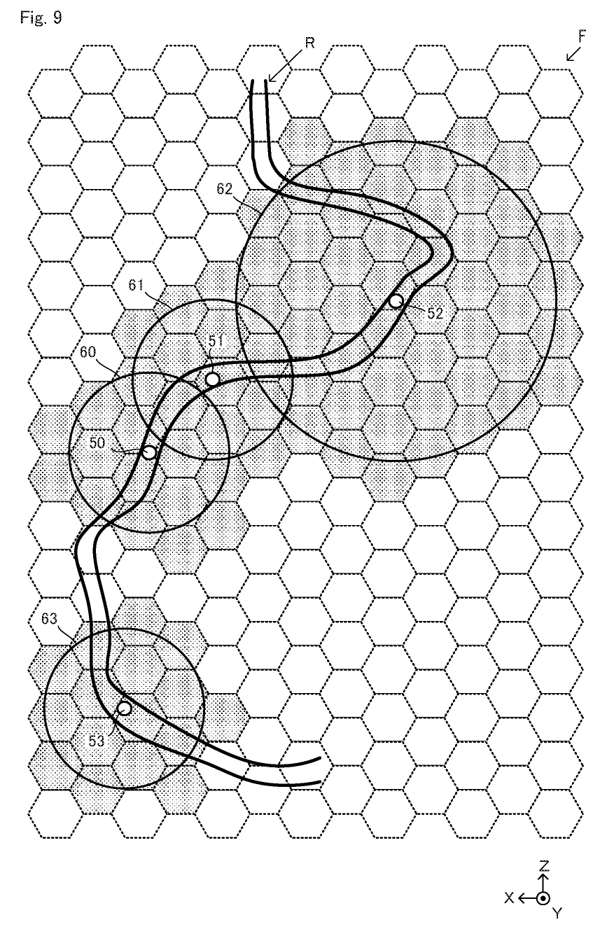

A region where rain falls through the use of the item X is specifically described. FIG. 9 is a diagram of a part of the field including the route R where the player object 50 is running when viewed from above in the virtual space and is a diagram showing examples of regions where rain falls.

As shown in FIG. 9, on the field F, the route R indicated by solid curves is set, and the player object 50 and the other movable body objects 51 to 53 run on the route R during the racing game. For example, at the current moment, the other movable body object 52 is ranking first, the other movable body object 51 is ranking second, the player object 50 is ranking third, and the other movable body object 53 is ranking fourth.

The virtual space is divided into regular hexagonal regions with respect to a horizontal direction (an XZ plane). For each of the regular hexagonal regions, a weather parameter indicating weather information is set. The weather parameter is a parameter indicating the degree of rainfall or snowfall and can take the range from "-1" to "1", for example. For example, if the value of the weather parameter is "0", this indicates that the weather of the region is a sunny weather. For example, if the value of the weather parameter is greater than "0" and less than or equal to "1", this indicates that the weather of the region is rain. The closer to "1" the value of the weather parameter is, the greater the amount of rainfall is. For example, if the value of the weather parameter is greater than or equal to "-1" and smaller than "0", this indicates that the weather of the region is snow. The closer to "-1" the value of the weather parameter is, the greater the amount of snowfall is.

If the item X is used, the weather parameters of regions in predetermined ranges centered at the movable body objects are set to the value indicating rain or snow. For example, as shown in FIG. 9, the weather parameters of filled regular hexagonal regions are set to the value indicating rain.

Specifically, if the player object 50 uses the item X, the weather parameters of regular hexagonal regions included in a circle 62 having a radius R1 centered at the position of the other movable body object 52 ranking first at the current moment are set to, for example, the value indicating rain. The weather parameters of regular hexagonal regions included in circles 60, 61, and 63 having a radius R2 (< R1) centered at the positions of all the movable body objects (50, 51, and 53) other than the other movable body object 52 ranking first are set to the value indicating rain. R1 and R2 may be fixed values. R1 may be set to 1000 m to 1500 m, for example, and R2 may be set to 400 m to 600 m, for example. R1 and R2 may be variable values.

If the weather parameters of regular hexagonal regions are set to the value indicating rain, a rain cloud object is generated at a predetermined position in the sky above the regular hexagonal regions (e.g., a position 500 m to 600 m above from the ground). In a region under the rain cloud object, if a game image is displayed, a raindrop effect 84 is displayed moving from above to below in the virtual space.

The main body apparatus 2 stores in advance a first texture image representing a sunny weather, a second texture image representing a rain cloud, and a third texture image representing a snow cloud. However, in the case of a form in which a rain cloud and a snow cloud are not distinguished from each other, the third texture image and the second texture image may not be separately stored. For example, before the racing game is started, any of a plurality of types of first texture images including various clouds 80 is randomly selected and applied to the entirety of the celestial sphere of the virtual space. During the racing game, if a rain cloud object is set in the sky above regular hexagonal regions, the first texture image and the second texture image are blended together in a region where the rain cloud object is set. Consequently, an image of the sky including a rain cloud 82 and normal clouds 80 as shown in FIG. 8 is generated and displayed.

In a boundary portion between a region where rain is not falling and a region where rain is falling, a value greater than "0" and smaller than "1" is set as the value of a weather parameter. A region where rain is falling inside the boundary portion is set to "1". Consequently, it is possible to cause rain to fall weakly in the boundary portion between the region where rain is not falling and the region where rain is falling, and it is possible to cause rain to fall strongly in the region where rain is falling inside the boundary portion.

During a predetermined period from the start of the production of the second effect (when rain starts falling), the rain may gradually strengthen. Specifically, during the predetermined period when rain starts falling, the weather parameters of regular hexagonal regions may be controlled to increase from 0 to 1 in accordance with the lapse of time.

If a certain time elapses after the start of the production of the second effect, the second effect becomes lost. That is, if the certain time elapses after rain starts falling through the use of the item X, the current weather returns to the previous weather. For example, after the weather parameter of a region where it is previously sunny is set to the value indicating rain through the use of the item X, the weather parameter of the region is set to the value indicating a sunny weather in accordance with the lapse of the certain time. Consequently, the rain in the region stops. During a predetermined period before rain completely stops, the rain may gradually weaken. Specifically, during the predetermined period before rain completely stops, the weather parameters of regular hexagonal regions may be controlled to decrease from 1 to 0 in accordance with the lapse of time.

Also in a region of which the weather parameter is set to the value indicating rain, rain does not fall if an object that blocks rain is present in the region (e.g., the inside of a tunnel). In this case, the ground does not become slippery, and does not have a wet appearance, either.

Which of the value indicating rain and the value indicating snow is set as the weather parameter of each region is determined in accordance with the place on the field F where a movable body object is running. For example, a particular place (e.g., a range including base area A11 to A13) where snow falls is set on the field F. In a case where a movable body object is running through the particular place, and if the item X is used, the value indicating snow is set for the weather parameters of regular hexagonal regions.

Also in a region where snow is falling, similarly to a region where rain is falling, movable body objects are likely to slip. A movable body object running in a region where snow is falling has an appearance where snow is attached to the movable body object, and the headlight of the movable body object also lights up. The virtual space in the region where snow is falling is darker than when it is sunny, and has a foggy appearance. The region where snow is falling may have an appearance where the ground is wet or the ground is covered with snow.

For example, the timing when the second effect is produced (the timing when rainfall or snowfall starts) may be a timing after the lapse of a predetermined time from the production timing of the first effect. For example, the first effect is produced at the timing when an instruction to use the item X is given by the player, and the second effect may start to be produced after the lapse of a predetermined time (e.g., after 1 second) from when the first effect starts to be produced. The timing of the start of the production of the second effect may be the same as the timing of the start of the production of the first effect. If an instruction to use the item X is given, the second effect may be produced first, and the first effect may be produced after that.

The centers of the circles (60 to 63) indicating the ranges where rain falls are set at the positions of the movable body objects at the timing when an instruction to use the item X is given by the player. Based on the rankings of the movable body objects at the timing when the player uses the item X, the radii of the circles (60 to 63) are set. The centers and the radii of the circles (60 to 63) may be set based on the positions and the rankings of the movable body objects at the timing of the start of the production of the second effect.

In the exemplary embodiment, the circles (60 to 63) indicating the ranges where rain falls do not move in accordance with the lapse of time. The circles indicating the ranges where rain falls may move in accordance with the lapse of time. For example, if a wind blows in the virtual space, the circles indicating the ranges where rain falls may move in the direction of the wind.

As described above, in the game according to the exemplary embodiment, if a movable body object uses the item X, the first effect of obstructing the running of a movable body object going ahead is produced, and rain or snow falls in regions corresponding to the positions of all the movable body objects participating in the racing game. Consequently, during the racing game, it is possible to cause rain or snow to locally fall in the positions where the movable body objects are.

Rain or snow falls in a wider range centered at a lead movable body object, and therefore, it is possible to prevent the lead movable body object from quickly passing through a region where rain or snow falls. Consequently, it is possible to prevent the difference between a lead movable body object and movable body objects other than the lead movable body object from becoming too great.

In the exemplary embodiment, while a movable body object is running on the field, rain or snow is controlled to fall in the virtual space also due to the occurrence of a second event, regardless of the use of the item X (the occurrence of the first event). The second event randomly occurs depending on time or place. For example, while a movable body object is running on the field, the ranges where rain falls are determined based on the place where and the time when the movable body object is running. The ranges where rain falls may be determined as ranges specified in advance in a predetermined scene, or may be randomly determined. If the ranges where rain falls are determined, the weather parameters of regular hexagonal regions included in the ranges are set to the value indicating rain. If a movable body object is running through a particular place on the field F, the ranges where snow falls are determined based on time. If the ranges where snow falls are determined, the weather parameters of regular hexagonal regions included in the ranges are set to the value indicating snow.

The second event randomly occurs, and may overlap the occurrence of the first event. For example, there is also a case where the item X is used in the state where rain is falling due to the occurrence of the second event. In this case, even if a region where rain has previously been falling is set as a region where rain falls due to the use of the item X, the state of the weather of the region does not change.

Also in a case where the racing game is performed in the single play mode, processing similar to the above is performed. In a case where the racing game is performed in the single play mode, a race is performed by a plurality of movable body objects including a player object and a plurality of other movable body objects controlled by the processor 21. Also in such a case, similarly to the above, the first effect and the second effect are produced in accordance with the use of the item X by any of the movable body objects.

### Details of Game Processes

Next, the details of game processing performed by the game system 1 are described. Data used in the game processing is described.

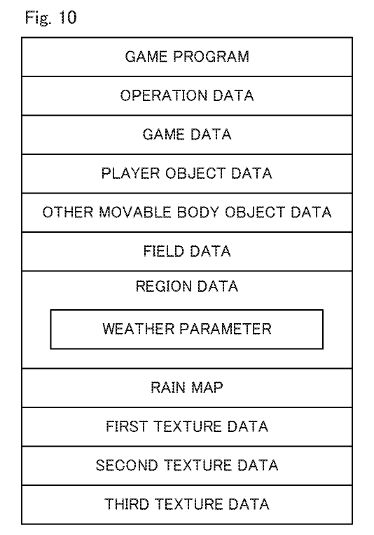

FIG. 10 is a diagram showing examples of various pieces of data stored in the game system 1. As shown in FIG. 10, a memory (e.g., the DRAM 27, the external storage medium attached to the slot 29, or the flash memory 26) of the game system 1 stores a game program, operation data, game data, player object data, other movable body object data, field data, region data, a rain map, first texture data, second texture data, and third texture data.

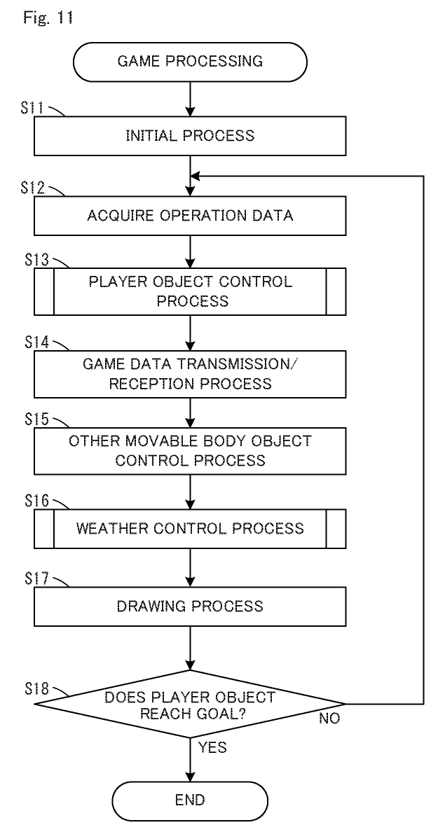

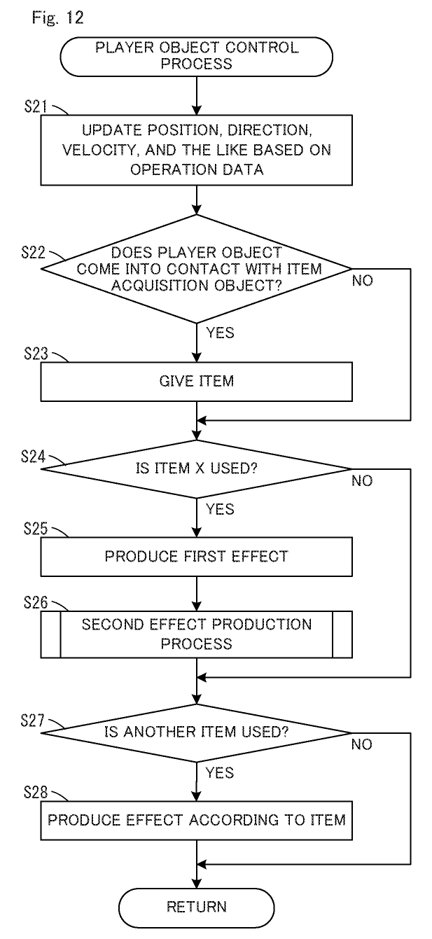

The game program is a program for executing processes described below (processes shown in FIGS. 11 to 15 described below). The game program is stored in advance in the external storage medium or the flash memory 26 and is loaded into the DRAM 27 when the game is executed.

The operation data is data according to an operation on the controllers connected in a wired or wireless manner to the main body apparatus 2. The operation data is transmitted from the controllers 3 and 4 to the main body apparatus 2 at predetermined time intervals (e.g., 1/200-second intervals).

The game data is data received from another main body apparatus 2 and includes data regarding another movable body object operated by another player. For example, the game data includes data regarding the position, the direction, the velocity, the moving direction, and the like of the other movable body object. The game data also includes data regarding an item possessed by the other movable body object, and data indicating that the other movable body object uses the item. The game data received from the other main body apparatus 2 also includes the weather parameters of regular hexagons set on the field.

The player object data is data regarding the player object 50 operated by the player of the main body apparatus 2. The player object data includes data indicating the position, the direction, the velocity, the moving direction, and the like of the player object 50, data regarding an item possessed by the player object 50, and data indicating that the player object 50 uses the item. The player object data also includes data indicating the shape and the state (e.g., a normal state, a wet state, or a snow-covered state) of the player object 50.

The other movable body object data is data regarding another player object (another movable body object) operated by another player. The other movable body object data includes data regarding each of the movable body objects (e.g., 51 to 53). Specifically, the other movable body object data includes data indicating the position, the direction, the velocity, the moving direction, and the like of the other movable body object, data regarding an item possessed by the other movable body object, and data indicating that the other movable body object uses the item. The other movable body object data also includes data indicating the shape and the state (e.g., a normal state, a wet state, or a snow-covered state) of the other movable body object.

The field data is data indicating the entirety of the field F and includes data indicating the ground. On the field, objects representing various grounds such as a road, a grassland, a sandy place, and the like and objects representing a wall, a building, and the like are set. The field data includes data indicating the type and the shape of the ground and data regarding the state (a slippery state, a wet state, a snow-covered state, or the like) of the ground.

The region data is data regarding the regular hexagonal regions set in the virtual space. The weather parameter is stored with respect to each of the regular hexagonal regions. The weather parameter is a parameter indicating the weather of the regular hexagonal region and set in the range from "-1" to "1", for example. The rain map is a two-dimensional map indicating a rain cloud or a snow cloud set based on the weather parameter. Based on the rain map, a rain cloud object is set in the sky above a region where a rain cloud is set.

The first texture data is image data regarding the first texture image representing a sunny weather. The second texture data is image data regarding the second texture image representing a rain cloud. The third texture data is image data regarding the third texture image representing a snow cloud. These pieces of data are prepared in advance in the external storage medium or the flash memory 26.

Next, the game processing performed by the game system 1 is described. FIG. 11 is a flow chart showing an example of the game processing. The game processing is started if an instruction to start the game is given by the player.

In the exemplary embodiment, the description is given on the assumption that the processes of steps shown in FIGS. 11 to 15 are executed by the processor 21 of the main body apparatus 2 executing the game program using a memory (e.g., the DRAM 27). In another exemplary embodiment, however, some of the processes of the steps may be executed by a processor (e.g., a dedicated circuit or the like) different from the processor 21. In a case where the game system 1 can communicate with another information processing apparatus (e.g., a server), some of the processes of the steps may be executed by the other information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 11, first, the processor 21 performs an initial process (step S11). Here, based on a selection operation of the player, the processor 21 determines a course to be used for a race among a plurality of courses defined in partial ranges of the field. Then, the processor 21 sets the determined course on the field and starts the racing game.

If the racing game is started, the processor 21 acquires operation data transmitted from the controllers 3 and 4 (step S12). From this point onward, the processor 21 repeatedly executes the processes of steps S12 to S18 at predetermined frame time intervals (e.g., 1/60-second intervals).

Next, the processor 21 executes a player object control process (step S13). Here, based on the operation data, the processor 21 updates the position, the direction, the velocity, the moving direction, and the like of the player object 50, updates the item possession state and the like, and causes the player object 50 to use an item. In accordance with the update of the position of the player object 50, the processor 21 also updates the position of the virtual camera. The details of the player object control process are described below.

### Player Object Control Process

FIG. 12 is a flow chart showing an example of the player object control process in step S13.

As shown in FIG. 12, based on the operation data, the processor 21 updates the position, the direction, the velocity, the moving direction, and the like of the player object 50 (step S21). For example, if the A-button is pressed, the processor 21 moves the player object 50 forward by a predetermined distance. In accordance with the input of the left-right direction of the analog stick of the left controller 3, the processor 21 updates the direction of the player object 50. The player object 50 runs along the set course.

Next, based on the position of the player object 50 and the position of the item acquisition object 70, the processor 21 determines whether or not the player object 50 comes into contact with the item acquisition object 70 (step S22).

If the player object 50 comes into contact with the item acquisition object 70 (step S22: YES), the processor 21 gives an item to the player object 50 (step S23). Specifically, based on the current ranking of the player object 50, the processor 21 randomly determines any of the plurality of types of items and gives the determined item to the player object 50. For example, if the current ranking of the player object 50 is low, the item X is likely to be given. If the current ranking of the player object 50 is high, the item X is less likely to be given. If the player object 50 is ranking first, the item X is not given.

If the determination is NO in step S22, or if the process of step S23 is executed, based on the operation data, the processor 21 determines whether or not the item X is used (step S24). The determination in step S24 is the determination of whether or not the first event occurs. Specifically, if the player object 50 is in the state where the player object 50 can use the item X (if the player object 50 possesses the item X and the item X is an item to be used next), the processor 21 determines whether or not an instruction to use the item is given by the player.

If the item X is used (step S24: YES), the processor 21 produces the first effect of the item X (step S25). Specifically, the processor 21 adds the effect image 78 to a movable body object running ahead of the player object 50. The processor 21 also brings the movable body object running ahead of the player object 50 into a disadvantageous state in the racing game. For example, the processor 21 temporarily decelerates the movable body object running ahead of the player object 50 or makes the movable body object small. The first effect of the item X continues for a certain time (e.g., 10 seconds).

Next, the processor 21 performs a second effect production process (step S26). Here, the processor 21 performs a process for causing rain or snow to fall on the peripheries of the movable body objects as the second effect of the item X. The details of the second effect production process in step S26 are described below.

### Second Effect Production Process

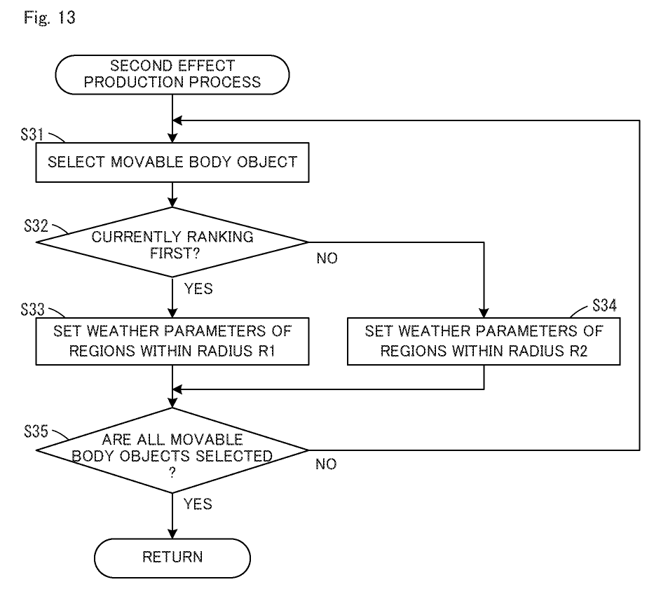

FIG. 13 is a flow chart showing an example of the second effect production process in step S26.

As shown in FIG. 13, the processor 21 selects any of the plurality of movable body objects (step S31).

Next, the processor 21 determines whether or not the selected movable body object is currently ranking first (step S32).

If the selected movable body object is currently ranking first (step S32: YES), the processor 21 sets the weather parameters of regular hexagonal regions included in a circle having the radius R1 centered at the position of the movable body object to the value indicating rain or snow (step S33). Specifically, in accordance with the place where the movable body object is located, the processor 21 determines whether to cause rain to fall or cause snow to fall. If it is determined that rain is to be caused to fall, the processor 21 sets the regular hexagonal regions included in the circle having the radius R1 to "1". If it is determined that snow is to be caused to fall, the processor 21 sets the regular hexagonal regions included in the circle having the radius R1 to "-1". If it is determined that rain is to be caused to fall, the processor 21 sets the weather parameters of regular hexagonal regions at the boundary between a region where rain falls and a region where it is sunny to a value greater than "0" and smaller than "1". If it is determined that snow is to be caused to fall, the processor 21 sets the weather parameters of regular hexagonal regions at the boundary between a region where snow falls and a region where it is sunny to a value greater than "-1" and smaller than "0".

If, on the other hand, the selected movable body object is not currently ranking first (step S32: NO), the processor 21 sets the weather parameters of regular hexagonal regions included in a circle having the radius R2 (< R1) centered at the position of the movable body object to the value indicating rain or snow (step S34). The process of step S34 is a process similar to that of step S33 except that the radius R2 is smaller than the radius R1.

The second effect of the item X is controlled to end after the lapse of a certain time (e.g., 20 seconds). That is, the weather parameters of the regions set in step S33 or S34 are returned to the previous values after the lapse of the certain time.

During a predetermined period from the start of the production of the second effect and a predetermined period before the end of the second effect, the weather parameters may be controlled to gradually increase or decrease in accordance with the lapse of time. The timing when the second effect is produced may not necessarily need to coincide with the timing when the first effect is produced. For example, the second effect may start to be produced after the lapse of a predetermined time from the timing when the first effect starts to be produced.

If the process of step S33 or S34 is performed, the processor 21 determines whether or not all the movable body objects are selected (step S35). If all the movable body objects are not selected (step S35: NO), the processor 21 executes the process of step S31 again. Consequently, a movable body object that has not yet been selected is selected.

If the determination is YES in step S35, the processor 21 ends the process shown in FIG. 13 and returns the processing to FIG. 12.

Referring back to FIG. 12, if the process of step S26 is executed, or if the determination is NO in step S24, based on the operation data, the processor 21 determines whether or not another item is used (step S27). Specifically, the processor 21 determines whether or not an instruction to use the item is given in a case where the player object 50 is in the state where the player object 50 can use the other item.

If the other item is used (step S27: YES), the processor 21 produces an effect according to the other item (step S28). Examples of the other item include an item having the effect of temporarily increasing the velocity of a movable body object that uses the item, an item having the effect of obstructing the running of a movable object going ahead by discharging a predetermined object forward in the virtual space, and the like. Here, an effect according to the type of the used item is produced. The item X is an item having an effect higher than another item in the game.

If the process of step S28 is executed, or if the determination is NO in step S27, the processor 21 ends the player object control process, and returns the processing to FIG. 11.

Referring back to FIG. 11, after the process of step S13, the processor 21 performs a game data transmission/reception process (step S14). Specifically, the processor 21 receives game data from another main body apparatus 2 performing the racing game. The game data received from the other main body apparatus 2 includes data indicating the position, the direction, the velocity, the moving direction, and the like of another movable body object operated by a player of the other main body apparatus 2, data indicating the item possession state of the other movable body object, and data indicating whether or not the other movable body object uses an item. The game data received from the other main body apparatus 2 also includes the weather parameters of regular hexagonal regions set by the other movable body object using the item X. The processor 21 also transmits game data based on the result of the player object control process in step S13 to the other main body apparatus 2. The game data to be transmitted to the other main body apparatus 2 includes data indicating the position, the direction, the velocity, the moving direction, and the like of the player object 50, data indicating the item possession state of the player object 50, and data indicating whether or not the player object 50 uses an item. The game data to be transmitted to the other main body apparatus 2 also includes the weather parameters of regular hexagonal regions set by the player object 50 using the item X.

Next, the processor 21 executes an other movable body object control process (step S15). Here, a process similar to the process performed on the player object 50 in the player object control process is performed on each of the other movable body objects. Specifically, based on the game data received from the other main body apparatus 2 in step S14, the processor 21 updates the position, the direction, the velocity, the moving direction, and the like of the other movable body object, causes the other movable body object to acquire an item, or causes the other movable body object to use an item. If the other movable body object uses the item X, and if the player object 50 is located ahead of the other movable body object, the first effect (the addition of the effect image 78, deceleration, or the like) is produced on the player object 50. If the other movable body object uses the item X, the second effect is produced on all the movable body objects.

Next, the processor 21 performs a weather control process (step S16). The weather control process is the process of controlling the weather of the virtual space based on the weather parameters set for the regular hexagonal regions. The details of the weather control process in step S16 are described below.

### Weather Control Process

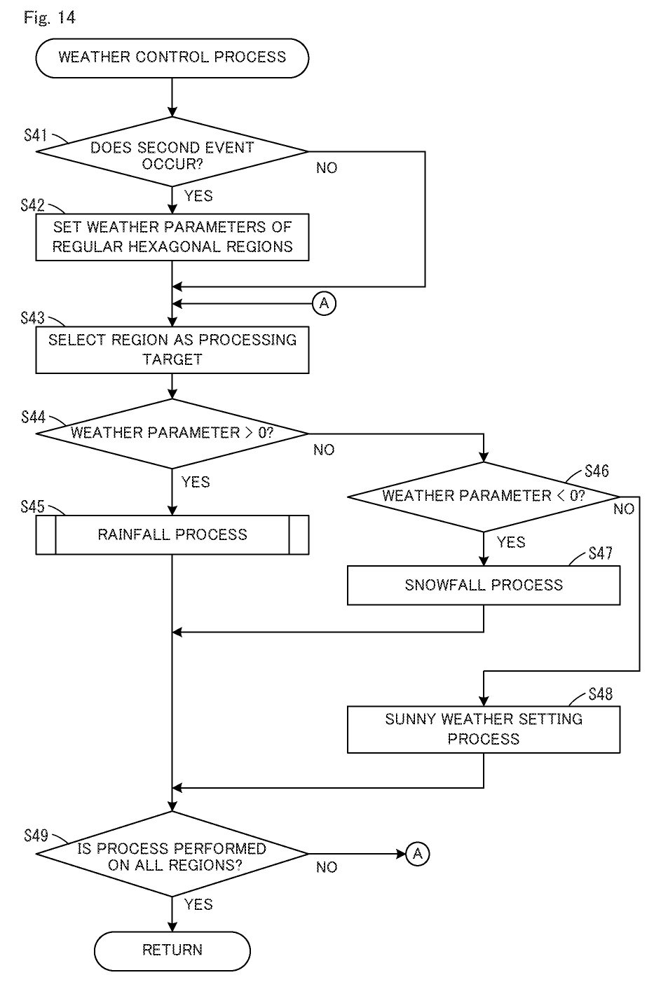

FIG. 14 is a flow chart showing an example of the weather control process in step S16.

As shown in FIG. 14, the processor 21 determines whether or not the second event occurs (step S41). The second event is an event different from the above instruction to use the item X (the occurrence of the first event). For example, the second event is randomly produced based on a location in the virtual space or time. The second event may be produced in accordance with the situation of the game in addition to (or instead of) a location on the field or time.

If the second event occurs (step S41: YES), the processor 21 sets the weather parameters of regular hexagonal regions (step S42). Specifically, the processor 21 determines the ranges where rain or snow is caused to fall in the virtual space. Then, the processor 21 sets the weather parameters of the regular hexagonal regions included in the determined ranges.

If the process of step S42 is executed, or if the determination is NO in step S41, the processor 21 selects a regular hexagonal region as a processing target (step S43).

Next, the processor 21 determines whether or not the weather parameter of the selected regular hexagonal region is greater than "0" (step S44).

If the weather parameter of the regular hexagonal region is greater than "0" (step S44: YES), the processor 21 performs a rainfall process on the region (step S45). Here, a process for causing rain to fall in the regular hexagonal region is performed. The details of the rainfall process in step S45 are described below.

### Rainfall Process

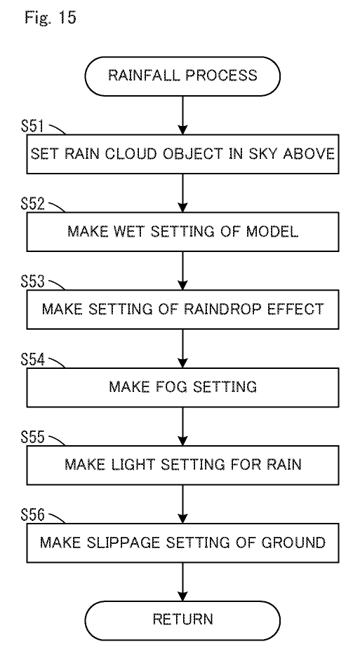

FIG. 15 is a flow chart showing an example of the rainfall process in step S45.

The processor 21 sets a rain cloud object in the sky above the selected regular hexagonal region (step S51). Next, the processor 21 makes a wet setting of a model (step S52). Specifically, the processor 21 makes a wet setting regarding a ground included in the regular hexagonal region and also makes a wet setting regarding a movable body object located in the regular hexagonal region. Consequently, the ground and the movable body object change to have wet appearances.

Next, the processor 21 makes a setting of a raindrop effect regarding the regular hexagonal region (a hexagonal prism region from the ground to the rain cloud object in the sky above) (step S53). The processor 21 also makes a fog setting regarding the hexagonal prism region (step S54) and makes a light setting for rain (step S55). Specifically, the processor 21 changes a light setting so that the region is darker overall than when it is sunny, and also makes a setting for causing the headlights of the movable body objects to light up.

The processes of steps S51 to S55 are performed, and a drawing process described below is performed, whereby a rain cloud 82 is displayed in the sky of the virtual space, and the state where a raindrop effect 84 falls in the hexagonal prism region below the rain cloud object is displayed. The wet ground and the wet movable body object are displayed, it is foggy in the virtual space, the region is darker than when it is sunny, and the headlights of the movable body objects light up.

Next, the processor 21 makes a slippage setting of the ground (step S56). Consequently, the ground of the regular hexagonal region becomes more slippery than normal (when it is sunny). If a movable body object runs on the ground where the slippage setting is made, the movable body object is likely to slip. If the process of step S56 is performed, the processor 21 ends the process shown in FIG. 15 and returns the processing to FIG. 14.

Referring back to FIG. 14, if the determination is NO in step S44, the processor 21 determines whether or not the weather parameter of the regular hexagonal region is smaller than "0" (step S46).

If the weather parameter of the regular hexagonal region is smaller than "0" (step S46: YES), the processor 21 performs a snowfall process (step S47). The process of step S47 is a process for causing snow to fall in the regular hexagonal region and is basically a process similar to the rainfall process in step S45, and therefore is not described in detail.

If the determination is NO in step S46, the processor 21 performs a sunny weather setting process (step S48). Here, the setting made in the rainfall process in the above step S45 is cancelled and returned to a normal sunny weather setting (a default setting).

If the process of step S45 is performed, or if the process of step S47 is performed, or if the process of step S48 is performed, the processor 21 determines whether or not the process is performed on all the regular hexagonal regions (step S49). If the process is not performed on all the regular hexagonal regions, the processor 21 executes the process of step S43 again. If the process is performed on all the regular hexagonal regions, the processor 21 ends the weather control process shown in FIG. 14 and returns the processing to FIG. 11.

Referring back to FIG. 11, after the process of step S16, the processor 21 performs a drawing process (step S17). The processor 21 generates a game image based on the virtual camera corresponding to the player object 50 and outputs the generated game image to a display device (the display 12 or an external display device). Here, a game image according to the weather control process is generated. For example, the processor 21 calculates a region of a rain cloud when the rain cloud object set in step S45 is viewed from the virtual camera. Then, the processor 21 blends the calculated region in the first texture image representing a sunny weather with the second texture image representing a rain cloud. Consequently, an image of the sky including a rain cloud 82 is drawn. If a wet setting is made regarding the ground or the movable body object included in the field of view of the virtual camera in step S45, the processor 21 draws an image of the wet ground or the wet movable body object. If a region (a hexagonal prism region) regarding which a raindrop effect is set in step S45 is included in the field of view of the virtual camera, the processor 21 further draws a raindrop effect 84 in the region. For example, if a raindrop effect is set regarding a region (a hexagonal prism region) where the player object 50 or the virtual camera is, the processor 21 further draws a raindrop effect 84 in the region. Consequently, a game image as illustrated in FIG. 8 is generated and displayed.

Next, the processor 21 determines whether or not the player object 50 reaches a goal set on the course (step S18). If the player object 50 reaches the goal, the processor 21 displays the result of the racing game and ends the processing shown in FIG. 11. If, on the other hand, the player object 50 does not reach the goal (step S18: NO), the processor 21 returns the processing to step S12. This is the description of the processing shown in FIG. 11.

The processes shown in the above flow charts are merely illustrative, and the order and the contents of the processes, and the like may be appropriately changed.

As described above, in the game according to the exemplary embodiment, any of a plurality of courses defined in partial ranges of a field is set on the field, and a race by a plurality of movable body objects including an operation target object (a player object) is started (step S11). Based on an operation input, the operation target object is caused to run on the field in the virtual space (step S13), and the operation target object and the movable body objects are caused to run along the course, thereby performing the race. Regarding a plurality of regions (regular hexagonal regions) defined by dividing the virtual space, based on weather information (a weather parameter) held with respect to each of the regions, a virtual weather in a range corresponding to each of the regions of the virtual space is controlled (step S16). If the first event occurs during the race (step S24: YES), the weather information regarding regions corresponding to the positions of the plurality of movable body objects is set to information indicating a first weather (e.g., rain or snow).

Consequently, courses are set in different portions on the field with respect to each race, and it is possible to change the weather of regions where a race is performed on the field and which include the places where the movable body objects are.

In the exemplary embodiment, information indicating the first weather is set for at least one regular hexagonal region corresponding to a first range including the position of each of movable body objects other than a lead movable body object and a regular hexagonal region corresponding to a second range larger than the first range and including the position of the lead movable body object. Consequently, it is possible to prevent the lead movable body object from immediately escaping from a region where the first weather is set.

In the exemplary embodiment, the first event is an obstruction instruction to obstruct another movable body object by any movable body object, and in accordance with the obstruction instruction, the effect of obstructing the running of another movable body object is produced (step S25). Consequently, it is possible to obstruct the running of another movable body object and further change the weather on the periphery of the other movable body object.

In the exemplary embodiment, if the item X is used, a rain cloud is generated on the peripheries of all the movable body objects, and rain falls. If the item X is used by another movable body object running ahead, the first effect is not produced on the player object running behind, but rain falls on the periphery of the player object. The rain cloud is generated in the sky ahead of the player object running behind. Thus, the player object running behind can recognize that the item X is used, and recognize that the other movable body object running ahead is in a disadvantageous state. Thus, the player object can take advantage of this opportunity to race.

In the exemplary embodiment, if the second event occurs, the weather information regarding any regular hexagonal region is set to information indicating the first weather (step S42). Consequently, for example, in a game where a weather randomly changes in accordance with time, if the first event occurs, it is possible to change the weather on the periphery of a movable body object.

### Variations

While the exemplary embodiment has been described above, the exemplary embodiment is merely an example and may be modified as follows, for example.

For example, in the above exemplary embodiment, the first event occurs by any of the plurality of movable body objects using the item X. In another exemplary embodiment, the first event may be another event that occurs during the game not only through the use of the item X. For example, the first event may occur by a movable body object reaching a predetermined place, or a movable body object performing a predetermined action.

In the above exemplary embodiment, if the first event occurs, the first effect of obstructing the running of another movable body object is produced, and the second effect of changing the weather is also produced. In another exemplary embodiment, if the first event occurs, the first effect may not be produced, and the second effect may be produced.

In the above exemplary embodiment, the virtual space is divided into a plurality of regular hexagonal regions with respect to the horizontal direction, and weather information is set for each of the regular hexagonal regions. The virtual space may be divided into not only regular hexagons, but also any shapes such as hexagons, pentagons, rectangles, triangles, or the like with respect to the horizontal direction.

In the above exemplary embodiment, the first effect is produced on a movable body object running ahead of a movable body object that uses the item X, and the weather information regarding the regions is set so that rain or snow falls on the peripheries of all the movable body objects. In another exemplary embodiment, the weather information may not be set so that rain or snow falls on all the movable body objects. For example, the weather information regarding the regions may be set so that rain or snow falls on only a movable body object running ahead of a movable body object that uses the item X.

In the above exemplary embodiment, if the first event occurs, rain or snow is caused to fall in at least one region included in a range having the radius R1 centered at the position of a lead movable body object and at least one region included in ranges having the radius R2 centered at the positions of movable body objects other than the lead movable body object. In another exemplary embodiment, the shapes of the ranges where rain or snow falls that are set corresponding to the positions of the movable body objects are not limited to circles, and may be any other shapes. For example, rain or snow may be caused to fall in at least one regular hexagonal region corresponding to the first range including the position of each of movable body objects other than a lead movable body object and at least one regular hexagonal region corresponding to the second range larger than the first range and including the position of the lead movable body object. Not only the first range and the second range, but also a third range having a size different from those of the first range and the second range may be set in accordance with the rankings of movable body objects.

In the above exemplary embodiment, rain or snow is caused to fall in a range having the radius R1 centered at the position of a movable body object ranking first at the point in time when the first event occurs, and rain or snow is caused to fall in ranges having the radius R2 (< R1) centered at the positions of all the movable body objects other than the movable body object ranking first. In another exemplary embodiment, rain or snow may be caused to fall in wider ranges corresponding to the positions of a predetermined number of movable body objects ranking high, and rain or snow may be caused to fall in narrower ranges corresponding to the positions of movable body objects other than the movable body objects ranking high.

In another exemplary embodiment, if the first event occurs, rain or snow may be caused to fall in ranges having the same size corresponding to the positions of all the movable body objects.

In the above exemplary embodiment, the weather parameter indicating the degree of rainfall or snowfall is set in the range from"-1" to "1". In another exemplary embodiment, the weather parameter may be another value.

In the above exemplary embodiment, if the first event occurs, rain or snow is caused to fall as the second effect. In another exemplary embodiment, another effect in which another weather changes may be produced. For example, if the first event occurs, a wind may occur, or a sandstorm may occur as the second effect. If the first event occurs, another object may fall from the sky. For example, an object advantageous or disadvantageous to each player may fall from the sky.

The above processing may be executed not only by the game system 1, but also by any other information processing apparatus or information processing system. The information processing system may include a plurality of apparatuses, and the plurality of apparatuses may be connected to each other via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors to perform operations comprising:
based on an operation input, causing an operation target object to run on a field in a virtual space;
regarding a plurality of regions defined by dividing inside of the virtual space, based on weather information held with respect to each of the regions, controlling a virtual weather in a range corresponding to the region in the virtual space;
setting any of a plurality of courses defined in partial ranges of the field on the field and starting a race by a plurality of movable body objects including the operation target object on the course;
performing the race by causing the operation target object and the movable body objects to run along the course on the field; and
during the race, if a first event occurs, setting the weather information regarding the regions corresponding to positions of the plurality of movable body objects to information indicating a first weather.

2. The one or more non-transitory computer-readable media according to claim 1, wherein
the weather information is a rainfall parameter indicating a degree of rainfall, and
the information indicating the first weather is a value of the rainfall parameter with which a rainfall process is performed at least by the controlling of the weather.

3. The one or more non-transitory computer-readable media according to claim 2, wherein
the operations further comprise
setting the field in a range where the rainfall process is being performed to be more slippery than in a case where the rainfall process is not being performed, and causing the movable body objects to run.

4. The one or more non-transitory computer-readable media according to claim 1, wherein
the operations further comprise
if the first event occurs during the race, setting the weather information regarding the at least one region corresponding to a first range including the position of each of the movable body objects other than a lead movable body object among the movable body objects in the race, and the region corresponding to a second range larger than the first range and including the position of the lead movable body object in the race to the information indicating the first weather.

5. The one or more non-transitory computer-readable media according to claim 1, wherein
the first event is a first obstruction instruction to obstruct another movable body object by any of the movable body objects, and
the operations further comprise
in accordance with the first obstruction instruction, further producing an effect of obstructing the running of the other movable body object.

6. The one or more non-transitory computer-readable media according to claim 5, wherein
the operations further comprise
in accordance with the first obstruction instruction,
producing an effect of obstructing the running of the other movable body object ranking higher than the movable body object for which the first obstruction instruction is given in the race; and
setting the weather information regarding the regions corresponding to the positions of all the movable body objects to the information indicating the first weather.

7. The one or more non-transitory computer-readable media according to claim 1, wherein
the plurality of regions are hexagonal regions adjacent to each other with respect to a horizontal direction.

8. The one or more non-transitory computer-readable media according to claim 1, wherein
the operations further comprise
if a second event occurs, setting the weather information regarding any of the regions to the information indicating the first weather.

9. The one or more non-transitory computer-readable media according to claim 1, wherein
the race is a multiplay race based on communication between a plurality of information processing apparatuses, and
the operations further comprise:
causing the plurality of information processing apparatuses to share the weather information regarding the region; and
controlling the virtual weather in the virtual space based on the shared weather information.

10. The one or more non-transitory computer-readable media according to claim 2, wherein
the operations further comprise
as the rainfall process, at least drawing a sky in a range corresponding to the region by a blending texture for a rain cloud.

11. The one or more non-transitory computer-readable media according to claim 2, wherein
the operations further comprise
as the rainfall process, if the operation target object or a virtual camera is within a range corresponding to the region, at least drawing rain.

12. An information processing method comprising:
based on an operation input, causing an operation target object to run on a field in a virtual space;
regarding a plurality of regions defined by dividing inside of the virtual space, based on weather information held with respect to each of the regions, controlling a virtual weather in a range corresponding to the region in the virtual space;
setting any of a plurality of courses defined in partial ranges of the field on the field and starting a race by a plurality of movable body objects including the operation target object on the course;
performing the race by causing the operation target object and the movable body objects to run along the course on the field; and
during the race, if a first event occurs, setting the weather information regarding the regions corresponding to positions of the plurality of movable body objects to information indicating a first weather.

13. The information processing method according to claim 12, wherein
the weather information is a rainfall parameter indicating a degree of rainfall, and
the information indicating the first weather is a value of the rainfall parameter with which a rainfall process is performed at least by the controlling of the weather.

14. The information processing method according to claim 13, further comprising
setting the field in a range where the rainfall process is being performed to be more slippery than in a case where the rainfall process is not being performed, and causing the movable body objects to run.

15. The information processing method according to claim 12, further comprising
if the first event occurs during the race, setting the weather information regarding the at least one region corresponding to a first range including the position of each of the movable body objects other than a lead movable body object among the movable body objects in the race, and the region corresponding to a second range larger than the first range and including the position of the lead movable body object in the race to the information indicating the first weather.

16. The information processing method according to claim 12, wherein
the first event is a first obstruction instruction to obstruct another movable body object by any of the movable body objects, and
the information processing method comprises
in accordance with the first obstruction instruction, further producing an effect of obstructing the running of the other movable body object.

17. The information processing method according to claim 16, further comprising
in accordance with the first obstruction instruction,
producing an effect of obstructing the running of the other movable body object ranking higher than the movable body object for which the first obstruction instruction is given in the race; and
setting the weather information regarding the regions corresponding to the positions of all the movable body objects to the information indicating the first weather.

18. The information processing method according to claim 12, wherein
the plurality of regions are hexagonal regions adjacent to each other with respect to a horizontal direction.

19. The information processing method according to claim 12, further comprising
if a second event occurs, setting the weather information regarding any of the regions to the information indicating the first weather.

20. The information processing method according to claim 12, wherein
the race is a multiplay race based on communication between a plurality of information processing apparatuses, and
the information processing method further comprises:
causing the plurality of information processing apparatuses to share the weather information regarding the region; and
controlling the virtual weather in the virtual space based on the shared weather information.

21. The information processing method according to claim 13, further comprising
as the rainfall process, at least drawing a sky in a range corresponding to the region by a blending texture for a rain cloud.

22. The information processing method according to claim 13, further comprising
as the rainfall process, if the operation target object or a virtual camera is within a range corresponding to the region, at least drawing rain.

23. An information processing system comprising:
one or more processors; and
one or more non-transitory computer-readable media storing instructions that, when executed, cause the one or more processors to perform operations comprising:
based on an operation input, causing an operation target object to run on a field in a virtual space;
regarding a plurality of regions defined by dividing inside of the virtual space, based on weather information held with respect to each of the regions, controlling a virtual weather in a range corresponding to the region in the virtual space;
setting any of a plurality of courses defined in partial ranges of the field on the field and starting a race by a plurality of movable body objects including the operation target object on the course;
performing the race by causing the operation target object and the movable body objects to run along the course on the field; and
during the race, if a first event occurs, setting the weather information regarding the regions corresponding to positions of the plurality of movable body objects to information indicating a first weather.

24. The information processing system according to claim 23, wherein
the weather information is a rainfall parameter indicating a degree of rainfall, and
the information indicating the first weather is a value of the rainfall parameter with which a rainfall process is performed at least by the controlling of the weather.

25. The information processing system according to claim 24, wherein
the operations further comprise
setting the field in a range where the rainfall process is being performed to be more slippery than in a case where the rainfall process is not being performed, and causing the movable body objects to run.

26. The information processing system according to claim 23, wherein
the operations further comprise
if the first event occurs during the race, setting the weather information regarding the at least one region corresponding to a first range including the position of each of the movable body objects other than a lead movable body object among the movable body objects in the race, and the region corresponding to a second range larger than the first range and including the position of the lead movable body object in the race to the information indicating the first weather.

27. The information processing system according to claim 23, wherein
the first event is a first obstruction instruction to obstruct another movable body object by any of the movable body objects, and
the operations further comprise
in accordance with the first obstruction instruction, further producing an effect of obstructing the running of the other movable body object.

28. The information processing system according to claim 27, wherein
the operations further comprise
in accordance with the first obstruction instruction,
producing an effect of obstructing the running of the other movable body object ranking higher than the movable body object for which the first obstruction instruction is given in the race; and
setting the weather information regarding the regions corresponding to the positions of all the movable body objects to the information indicating the first weather.

29. The information processing system according to claim 23, wherein
the plurality of regions are hexagonal regions adjacent to each other with respect to a horizontal direction.

30. The information processing system according to claim 23, wherein
the operations further comprise
if a second event occurs, setting the weather information regarding any of the regions to the information indicating the first weather.

31. The information processing system according to claim 23, wherein
the race is a multiplay race based on communication between a plurality of information processing apparatuses, and
the operations further comprise:
causing the plurality of information processing apparatuses to share the weather information regarding the region; and
controlling the virtual weather in the virtual space based on the shared weather information.

32. The information processing system according to claim 24, wherein
the operations further comprise
as the rainfall process, at least drawing a sky in a range corresponding to the region by a blending texture for a rain cloud.

33. The information processing system according to claim 24, wherein
the operations further comprise
as the rainfall process, if the operation target object or a virtual camera is within a range corresponding to the region, at least drawing rain.
